(19) United States
(12) Patent Application Publication
(10) Pub. No.: US 2011/0145859 A1
(43) Pub. Date: Jun. 16, 2011

(54) SYSTEM AND METHOD FOR DETACHABLE MEDIA DEVICES AND CONTENT

(75) Inventors: Brian M. NOVACK, St. Louis, MO (US); David Dunmire, San Antonio, TX (US); Jason Eugene Hicks, Edwardsville, IL (US)

(73) Assignee: AT&T Intellectual Property I, L.P., Reno, NV (US)

(21) Appl. No.: 12/638,622

(22) Filed: Dec. 15, 2009

(51) Int. Cl. G06F 13/00; H04N 7/173

(52) U.S. Cl. 725/38; 725/116

(57) ABSTRACT

Disclosed herein are systems, computer-implemented methods, and computer-readable storage media for detachable media playback. The system can detach individual channels of a media presentation from a first device and transfer them to nearby devices. The method causes a computing device to play media content having multiple channels to a user on a first device, identify a set of media playback devices nearby to the first device, identify playback capabilities and a status for each of the set of nearby devices, match a channel of the media content with at least one of the set of media playback devices and the identified playback capabilities and the status of the set of media playback devices, and transfer the matched channel to the at least one of the set of media playback devices. A central server can transfer the matched channel to other media playback devices.

### BACKGROUND

1. Technical Field

The present disclosure relates to media playback and more specifically to fragmentable, detachable, and adaptable presentation of media content which breaks the binding between media content and media content presentation devices.

2. Introduction

Currently, users who consume media (i.e. listens to music, watches a movie, talks on a telephone, etc.) are bound to the presentation device itself, such as a cellular phone, DVD player, or portable media player (PMP). However, when the user desires to break that binding by going into their car, the presentation of the content must be terminated. The media does not follow the user into their car, onto a boat, or going around a jogging track. TiVo allows content transfers to another device by transferring the entire recording across devices. This limitation binds users to the devices that TiVo supports, such as TiVo digital video recorders (DVRs) and personal computers running TiVo software.

SlingBox serves media content from a SlingBox set top box, but the user is still bound to the device and is unable to take the content with them as they go about their business without a system capable of receiving the served content. For example, the SlingBox approach fails as soon as the user goes jogging or gets on an airplane.

Both wired and wireless telephones are similarly limited. If a user desires to take a wire-line phone call with them when they leave the house, they can not without first ending the call and then re-establishing it on a wireless phone. If a user on a wireless call wants to move the call to their wire-line phone, they are unable to do so as well. Many conference call participants join the call on a cell phone in their car, but when they get to the office and to their desk, they are stuck on their cell phone unless they disconnect and re-establish the call. Presentation device selection is something that users control, but the existing limitations of devices, the networks, and the user interfaces all drive how these systems behave.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example method embodiment;

FIG. 3 illustrates an example media playback device and nearby media playback devices; and

FIG. 4 illustrates media content having detachable channels.

### DETAILED DESCRIPTION

This disclosure enables the presentation of media content to become partially or completely detached from and transferable to disparate Media Presentation Devices (MPD). Some additional interfaces and/or integration points can add unique features and capabilities. The first addition is a “ContentProvider” interface that manages or processes requests to serve content (live or pre-recorded, unidirectional or bidirectional) to a specific IP address and/or device address, such as a MAC address. The second addition is a “Centralized Server” or “Manager” that manages or processes requests between content consumers and producers. This includes the handling of authorization, billing, requests, responses, terminations/end of sessions, data, etc. The third addition is an interface that integrates between the “Media Content Presentation Devices”, “Centralized Server/Manager,” and the user. The fourth addition is an interface to “Media Content Presentation Devices.” This allows the receiver to receive content, broadcasts, data, communication sessions, etc. as well as provides the capability for self identification of device and capabilities to other devices and interfaces.

The principles disclosed herein are perhaps best illustrated by the example of a person on a conference call who needs to switch from their mobile phone to a desk phone. With this approach, the person only need move close enough to the desk phone and with the press of a button the network retargets the path for the conversation from the wireless device to the desk phone. Video conferencing can be implemented very much the same way, for example transitioning from a camera-enabled smart phone to a dedicated videoconferencing terminal. Another example is when a person goes to the gym to workout on a stationary bike with an integrated liquid crystal display (LCD). The person can continue watching the movie they were just watching on their personal video player on the integrated LCD. The user can move their player to the device and instead of transferring the complete media stream, the personal video player identifies the LCD display device and its capabilities, such as through a radio-frequency identification (RFID) handshake, and transfers only the video portion to the LCD display device through a Bluetooth network connection or other local or wide area connection. The personal video player continues to play the audio through the earphones. When the person is done exercising on the stationary bike, they walk away from the device and the RFID connection between the personal video player and the stationary bike is broken. The personal video player identifies that the connection is broken and transfer the video portion back to itself. The player can restart the video or stay on audio only depending on its user interface considerations.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

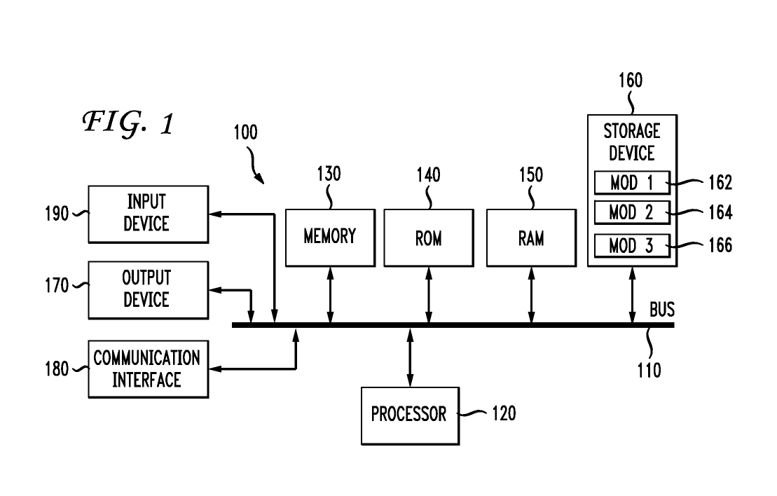

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. These and other modules can be configured to control the processor 120 to perform various actions. Other system memory 130 may be available for use as well. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 may be used by the presenter to indicate the beginning of a speech search query. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Generally speaking, such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

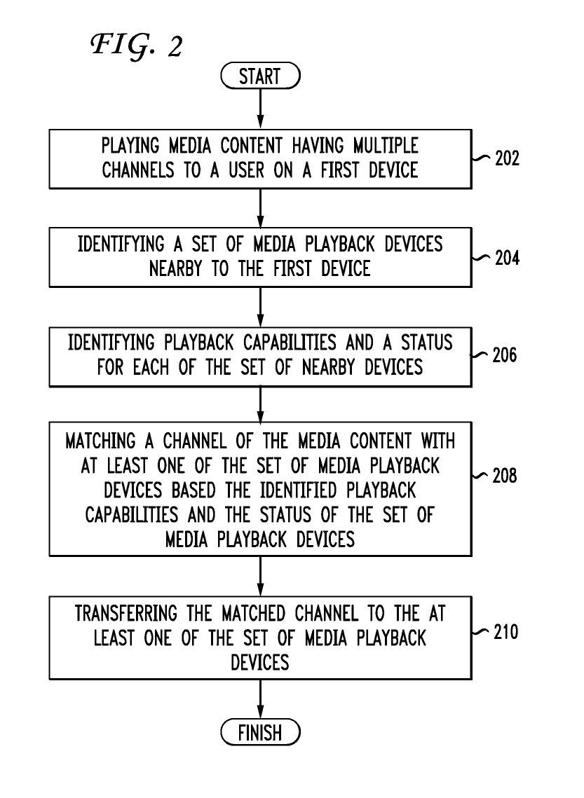

Having disclosed some basic system components, the disclosure now turns to the exemplary method embodiment shown in FIG. 2. For the sake of clarity, the method is discussed in terms of an exemplary system 100 such as is shown in FIG. 1 configured to practice the method and further in terms of an exemplary situation of Lisa listening to music on her portable media player as she enters a gym to exercise on a treadmill. However, the portable media player can also be the source of the media content, such as audio and/or video from a camera and microphone in the portable media player. The system 100 can include one or more device, such as a central server or the portable media player. FIG. 2 illustrates the method for detachable media playback. The system 100 plays media content having multiple channels to a user on a first device (202). The media content can be audio, video, multimedia, a telephone conversation or video conference, or any media component of a larger presentation. The first device can be Lisa's Apple iPhone or other portable media player, on which she is watching a movie. The system 100 identifies a set of media playback devices nearby to the first device (204). The system 100 can include the portable media player, a remote server, one or more part of a mesh network, a network registry, a central server, etc. Nearby devices can be determined based on GPS location, a pre-programmed location, local area network connectivity, signal strength, RFID handshake, network address, and/or other indicators. For example, as Lisa walks toward a treadmill, the iPhone can identify the Bluetooth-enabled treadmill using a Bluetooth signal.

The system 100 identifies playback capabilities and a status for each of the set of nearby devices (206). If the system 100 is the portable media player, the system can request the information directly from the treadmill or from a remote server. If the system 100 is a remote server, the system can retrieve that information from a database using a unique device identifier or request it from the treadmill. For example, the system 100 can identify that the treadmill has no audio output capabilities, but has an integrated LCD monitor at 640×480 resolution and 8 bit color and capacity to scroll text on a separate, lower resolution non-backlit LCD. The system 100 matches a channel of the media content with at least one of the set of media playback devices, potentially based on user input, and the identified playback capabilities and the status of the set of media playback devices (208). In the example of Lisa, the system 100 detaches the video channel of the media content playing on the portable media device and transfers it to the treadmill without interrupting the audio portion. In this manner, Lisa can continue enjoying the media presentation without interruption as she starts using the treadmill. The transition can be automatic or can be based on user input. User input can be multimodal and can include previously established user preferences, movement (as measured by an accelerometer, for example), etc. In one specific example, Lisa places the iPhone into a pocket or receptacle integrated with or near to the treadmill. Sensors inform the iPhone that the treadmill is nearby and can automatically trigger a transfer of one or more media channel to the treadmill as long as the iPhone is in the pocket or receptacle. The user can direct input to the first device, the desired nearby device or devices, or both. User preferences can be based on location, device, capability, type of media, time of day, and so forth, and can apply on a per media basis.

The system 100 transfers the matched channel to the at least one of the set of media playback devices (210). The system can transition the playback smoothly from the first to the nearby device. One way to transition is to fade one in as the other fades out. Another way is to overlap playback on both for a period of time. In one aspect, the system 100 adapts the matched channel to the playback capabilities of the nearby device. In the example above, the treadmill monitor is 640×480 resolution and 8 bit color. The system can upscale or downscale video output based on that resolution. The system can also transcodes or adapt the bit-rate of media to match the processing power and decoding abilities of nearby devices. For example, perhaps the treadmill can only display MPEG2 video, but the source is encoded as MPEG4. The system can transcode the video channel or can select an appropriately coded channel.

In one aspect, the system 100 communicates with a centralized server to authorize transferring the matched channel to the nearby device. The centralized server can be the same as or separate from a content server from which the playback device receives the media content. The authorization can be based on a customer subscription, authorization rules, copyright laws, and other suitable criteria. Further, security mechanisms can be included at a device-level and/or at a channel level. Security mechanisms can include encryption, credential verification, handshakes, and so forth. The system can secure the handoff process of a channel to another device. Those of skill in the art will appreciate how to incorporate security features into the features and functionality disclosed herein. In one aspect, a device can transfer a full channel only to other secured devices, and a lesser channel to devices which are not secure. For example, a secure device can receive a full surround sound audio channel, but a device which is not secure can receive only a monaural audio channel.

In another aspect, the system detects that the nearby device is no longer nearby and terminates channel transfers to devices which are no longer nearby. For example, the system 100 can detect that Lisa is no longer near the treadmill. In this case, the system can stop transferring the video channel to the treadmill. The system can take several courses of action in this scenario. First, the system can select a replacement nearby device divert the terminated channel transfer to the replacement nearby device. This approach works if Lisa is moving to a stationary bike, for example. Second, the system can duplicate the terminated channel to all currently available nearby devices so Lisa can select which one she wants to continue watching on. Third, the system can terminate the transfer of the media channel and return playback of the detached channel to the portable media player.

A server can process requests for transferring channels of detachable media playback. The server can be a computing device 100 with a processor as shown in FIG. 1. The server can include a module that controls the processor to receive a request to transfer from a first device to a second device near to the first device at least one channel of a detachable media presentation, a module that controls the processor to determine at least one requirement associated with the detachable media presentation, and a module that controls the processor to authorize the request to transfer the at least one channel based on the determined at least one requirement. The server can determine the requirement based on interactions with a third party, such as a media content publisher or a producer of at least part of the detachable media presentation. The requirement can include at least one of billing information, copyright restrictions, durational limits, bit-rate limits, video quality, and audio quality. For example, a content publisher can restrict free transfers of audio channels to 48 Kbps and charge a fee for higher bitrates, or a content publisher can restrict playback to only approved classes of devices to ensure optimal playback conditions. In these cases, the server can suggest or pre-authorize a suggested alternative transfer in response to the request, such as a transfer to a different nearby device or a transfer of a different channel or at a different quality level.

A computer-readable storage medium can store instructions which, when executed by a computing device, cause the computing device to transfer a detachable media presentation to a separate output device according to the method illustrated in FIG. 2. The instructions can include receiving a user request to transfer a channel of a detachable media presentation currently playing on a first device, identifying a set of devices nearby to the first device and their respective playback capabilities and status, selecting one of the set of nearby devices with playback based on the one's status and playback capabilities relative to the channel, and transferring the channel to the selected one of the set of nearby devices for output. The instructions can disable output of the transferred channel on the first playback device or duplicate the channel on the first playback device and the nearby device. The user request can be an explicit or an implicit user action. An example of an explicit user action is pressing a button on a nearby device labeled “transfer a media channel to this device.” An example of an implicit user action is walking up to a treadmill while user preferences are set to enable channel transfers to that treadmill automatically.

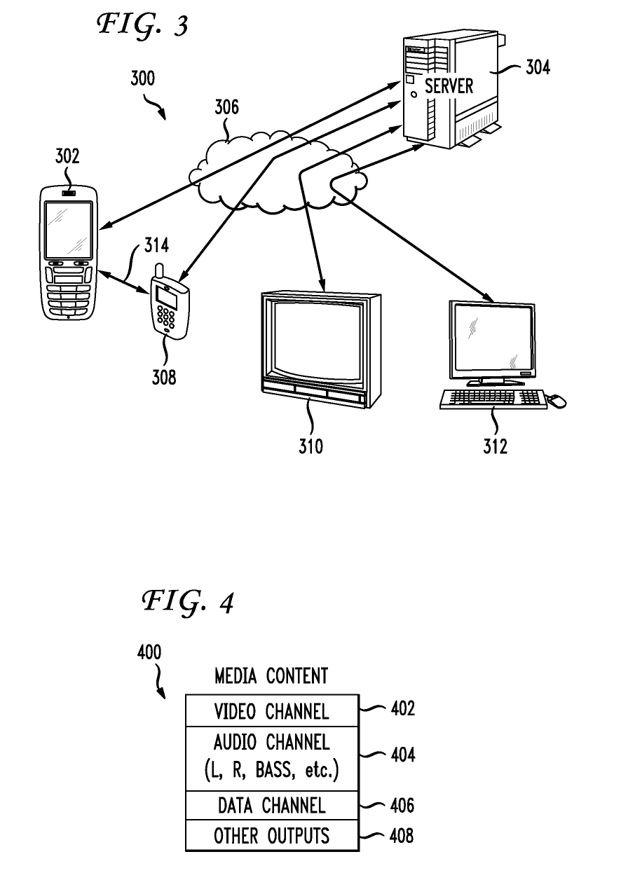

FIG. 3 illustrates an example configuration 300 of a media playback device 302 such as a personal digital assistant (PDA), smartphone, or other capable device, nearby media playback devices 308, 310, 312, and their interactions with a central server 304. The media playback device 302 communicates with the server 304 and/or other devices through a network 306, such as a cellular telephone network. The media playback device can send the audio channel of a media presentation for playback on its own speakers or headphones at full or half duplex. The media playback device can transfer a video channel of the media presentation to a dedicated display device 310 or a personal computer 312. The server 304 can be a resource manager which tracks devices and their capabilities. The server 304 can then enable the managed use of the devices as users move in and out of range of various devices. The server 304 can also be a content server which stores and serves media content to devices. The content server and resource manager server can be separate or integrated. In one aspect, the media playback device 302 detects a nearby device 308 through a personal area network 314 using protocols such as infrared, Bluetooth, wireless USB, or ZigBee.

FIG. 4 illustrates media content 400 having detachable channels. The media content can include one or more video channel 402, one or more audio channel 404, one or more data channel 406, and one or more other output channel 408. For example, video can be divided into different portions of the screen, such as a left video and a right video channel, or into a full screen and a wide screen channel. Audio channels 404 can include left, right, bass, 5.1 or 7.1 surround sound channels, and so forth. Data channels 406 can include closed captions, song lyrics, cover art, credits, lists of related media, advertising, price or subscription information, network resources, an SMS or other instant message, an Internet connection, etc. Other outputs 408 can include specific device or usage profiles. For example, when a user watches a movie on a portable media player and walks into a home theater, the system 100 can look up a home theater usage profile and divide the audio channels up to the surround sound speakers while still retaining a portion of the audio or other output for the portable media player such that loud sounds not only come from the speakers, but from the portable media player in the pocket of the user. Other outputs can also include instructions to vibrate, flash an LED, and/or provide any other outputs of which the playback device is capable.

The principles herein allow for fragmentable, detachable, and adaptable media content presentation which breaks the binding between media content and the Media content Presentation Devices (MPDs). Media content today is already channelized, such that different and distinct channels contain different portions of content, such as video, monaural audio, stereo audio, surround sound, lyrics, subtitles, video channels such as color, black/white, and wide/full/handheld screen. Even the telephone communications include different channels such as voice, data (text and web), and feature controls (Enhanced Call Waiting). This approach can detach media content channels in a manner similar to the approach used in the Distributed Computing Environment (DCE). In DCE, several components can be of use here. Resource Managers or Directory Servers capture and provide information related to the MPD, such as the name of the device, its network address, and presentation capabilities. Presentation capabilities are important because if a device such as a video monitor is available but it does not have any audio capabilities, it could not make use of an audio channel feed. Also, a bi-directional connection with a video monitor would not necessarily be appropriate. But if that monitor did have audio capabilities the system can provide it with an audio channel from the media content. Resource management can occur at the network level and/or the local level in a managed or ad hoc fashion.

At a network level, resources can identify themselves, and through the use of authorization rules, only make themselves visible or available to authorized users. At a local level, devices/components introduction can be accomplished with RFID tags, bar codes, or even through network broadcasts that are limited to a particular LAN/WAN segment. Some devices, such as a TiVo, IPTV, or SlingBox can originate stored content to other devices or transfer (or copy) the media content to other devices. In either case, the Resource Manager knows each device's capabilities. The absence of a published capability can indicate that the device does not have the capability. MPDs can further indicate their availability status to the appropriate Resource Manager so that if a device is busy, such as with displaying another media stream, the Resource Manager would not select it for another task.

In some situations an overlap is needed and can be desirable. While a video monitor is showing a movie, the Resource Manager can insert or overlay video of the caller id perhaps with a photo and other information on the video device. The user can take the call by picking up the phone through its MPD User Interface or dispose of the call in another manner.

Various mechanisms can provide a mechanism for devices to detect other devices, such as Bluetooth, infrared, RFID, WiFi, GPS, wireless USB, ZigBee wireless mesh networking, and/or other modes of communication that would be easily deployed to suit a wide variety of wireless scenarios. In one aspect, inter-device communications use a standard device-to-device protocol over any kind of wired and/or wireless connection. Wired solutions such as Ethernet can be especially well suited for fixed devices such as televisions, stereo systems, or the internal systems within a car, plane, or train. Fixed device can also include wired and wireless elements to more closely integrate with mobile/wireless user devices.

The approach disclosed herein can directly benefit both the suppliers and consumers of media content, in all its various forms. Consumers can get unrivaled access to the content and communications features. Because of this, suppliers of media content and service providers can remain bonded to the consumer without asking the consumer to sacrifice as they do today with hard wired, physically bound solutions. Consumers are able to take products and services from media content providers with them wherever they go.

Embodiments within the scope of the present disclosure may also include tangible computer-readable storage media for carrying or having computer-executable instructions or data structures stored thereon. Such computer-readable storage media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein also apply to moving a live phone call as media content from a cell phone to a nearby voice over IP computer or to a nearby landline phone. Those skilled in the art will readily recognize various modifications and changes that may be made to the principles described herein without following the example embodiments and applications illustrated and described herein, and without departing from the spirit and scope of the disclosure.

We claim:

1. A computer-implemented method for detachable media playback, the method causing a computing device to perform steps comprising:
playing media content having multiple channels to a user on a first device;
identifying a set of media playback devices nearby to the first device;
identifying playback capabilities and a status for each of the set of nearby devices;
matching a channel of the media content with at least one of the set of media playback devices and the identified playback capabilities and the status of the set of media playback devices; and
transferring the matched channel to the at least one of the set of media playback devices.

2. The computer-implemented method of claim 1, further comprising authorizing transferring the matched channel with a centralized server.

3. The computer-implemented method of claim 1, further comprising adapting the matched channel to the playback capabilities of at least one of the set of nearby devices.

4. The computer-implemented method of claim 1, wherein matching a channel of the media content is further based on user input.

5. The computer-implemented method of claim 4, wherein the user input includes one or more of user movement and user preferences.

6. The computer-implemented method of claim 1, the method further comprising:
detecting that at least one of the at least one of the set of nearby devices is no longer nearby; and
terminating channel transfers to devices which are no longer nearby.

7. The computer-implemented method of claim 6, the method further comprising:
selecting a replacement nearby device; and
diverting the terminated channel transfer to the replacement nearby device.

8. A server for processing requests for transferring channels of detachable media playback, the system comprising:
a processor;
a module that controls the processor to receive a request to transfer from a first device to a second device near to the first device at least one channel of a detachable media presentation;
a module that controls the processor to determine at least one requirement associated with the detachable media presentation; and
a module that controls the processor to authorize the request to transfer the at least one channel based on the determined at least one requirement.

9. The server of claim 8, wherein the system determines the at least one requirement based on interactions with a third party.

10. The server of claim 9, wherein the third party is a producer of at least part of the detachable media presentation.

11. The server of claim 8, wherein the at least one requirement includes at least one of billing information, copyright restrictions, durational limits, bit-rate limits, video quality, and audio quality.

12. The server of claim 8, further comprising a module that controls the processor to authorize a suggested alternative transfer in response to the request.

13. A computer-readable storage medium storing instructions which, when executed by a computing device, cause the computing device to transfer a detachable media presentation to a separate output device, the instructions comprising:
receiving a user request to transfer a channel of a detachable media presentation currently playing on a first device;
identifying a set of devices nearby to the first device and their respective playback capabilities and status;
selecting one of the set of nearby devices with playback based on the one's status and playback capabilities relative to the channel; and
transferring the channel to the selected one of the set of nearby devices for output.

14. The computer-readable storage medium of claim 13, the instructions further comprising disabling output of the transferred channel on the computing device.

15. The computer-readable storage medium of claim 13, the instructions further comprising duplicating the channel on the computing device and the selected one of the set of nearby devices.

16. The computer-readable storage medium of claim 13, wherein the user request is an explicit user action.

17. The computer-readable storage medium of claim 13, wherein the user request is an implicit user action.

18. The computer-readable storage medium of claim 13, the instructions further comprising authorizing transferring the channel with a server.

19. The computer-readable storage medium of claim 13, the instructions further comprising:
detecting that the selected one of the set of nearby devices is no longer nearby; and
terminating channel transfers to the selected one which is no longer nearby.

20. The computer-readable storage medium of claim 19, the instructions further comprising:
selecting a replacement nearby device based on the replacement device's status and playback capabilities relative to the channel; and
diverting the terminated channel transfer to the replacement nearby device.
